(19) United States
(12) Patent Application Publication
(10) Pub. No.: US 2006/0169904 A1
(43) Pub. Date: Aug. 3, 2006

(54) Active polarization-resolving infrared imager

(76) Inventors: Joseph E. Grobmyer, Huntsville, AL (US); William C. Pittman, Huntsville, AL (US)

Correspondence Address: AMSAM-L-G-I (Ms. Anne Lanteigne);US Army Aviation and Missile Command, Legal Office, Building 5300, 4th Floor, Redstone Arsenal, AL, 35898-5000, US

(21) Appl. No.: 11/045,660

(22) Filed: Jan. 31, 2005

(51) Int. Cl. G01J 5/02

(52) U.S. Cl. 250/341.4

(57) ABSTRACT

The Active Polarization-Resolving Infrared Imager improves the function of the passive polarization-resolving infrared imager of U.S. Pat. No. 6,310,345 by employing a laser to illuminate actively the selected target scene and a means for selectively changing the polarization orientation of the beam emitted by the laser. The polarization of the outgoing beam is maintained in synchronism with the orientation of the polarization filters associated with the passive detector device. As a result, the received signals are maximized on the items or articles in the target scene that preserve the original polarization. Such items (usually man-made) stand out against random nature background which tends to diffuse polarization. Thus, the user of the active imager is more accurately cued to non-naturally occurring areas or objects of interest, such as tanks and other items containing geometric structure, due to relatively high degree of polarization preservation by such items.

### DEDICATORY CLAUSE

The invention described herein may be manufactured, used and licensed by or for the Government for governmental purposes without the payment of any royalties to us.

### BACKGROUND OF THE INVENTION

Infrared polarimetry has potential applications in astronomy, space exploration, material characterization, semiconductor manufacturing, microscopy for biological measurements and, not the least of all, characterization of military targets. However, for the last-mentioned application, infrared polarimetry is still a relatively immature technology that is not currently a part of fielded military hardware. The reasons are that the instrumentation developed for research and development endeavors is limited in sensitivity and optical components in such instrumentation, as well as optical coatings, scattering and birefringence effects in the instrument, can cause unintended changes in the polarization to be measured, all to the detriment of target identification accuracy. In addition, during the process of dividing the incoming radiation to obtain measurements of the individual components of polarization, the sensitivity of the measurements may be further reduced.

U.S. Pat. No. 6,310,345 (Oct. 30, 2001) for a polarization-resolving infrared imager provides a passive means of sensing polarized infrared radiation. The passive imager employs the configuration of either first-generation (60 horizontal rows by 1 vertical column of detector elements) or second-generation (at least 240 horizontal rows by 4 vertical columns of detector elements) infrared imaging detector devices and polarization filters that work in conjunction with the infrared imaging detector devices to separate incoming infrared radiation into portions, each portion having a different polarization orientation. Such polarization separation enables the production of visible images in which various aspects of the scene are differentiated. In the preferred embodiment using the second-generation infrared imaging detector device, polarization-filtering grids are integrated onto the detector elements. The detector elements in three of the four columns have coupled thereto polarization filtering elements to filter 0 (horizontal), 90 (vertical) and 45-degree polarizations, respectively, of the incoming infrared radiation. Using a scan mirror of sufficient sweep in conjunction with the detector device and the polarization-filtering grid results in one frame of the target scene with horizontal polarization, one frame with vertical polarization, one frame with 45-degree polarization and a frame with no polarization distinction, all with one sweep of the scan mirror in real-time scenario. This provides nearly simultaneous infrared target scenes at different polarization from a single cycle of the scan mirror.

However, due to the limitations of current infrared polarimetric instrumentation, there are still many unknowns in the process of characterizing military targets in a natural or man-made clutter background. The principles of characterization of radiation emanating from simple geometric objects such as spheres, cylinders or plane surfaces are well understood in static, controlled environments; but the radiation emanating from a complex object such as a tank that can be modeled with literally thousands of plane surfaces containing a thermal source viewed from, say, a moving platform, such as an unmanned aerial vehicle or a missile, has not been systematically characterized. The fact that the measurements are passive means that they are heavily influenced by the diurnal and seasonal variation in the thermal loading that the sun imposes on the earth.

### SUMMARY OF THE INVENTION

The Active Polarization-Resolving Infrared Imager improves on the passive polarization-resolving infrared imager of U.S. Pat. No. 6,310,345 by adding a laser to illuminate actively the selected target scene and a means for selectively changing the polarization orientation of the beam emitted by the laser in synchronism with the switching of the polarization filters associated with the passive detector device. The result is received signals that are maximized on the items or articles, such as geometric or regular structure in the target scene, that preserve the original polarization. Such items stand out against random nature background which tends to diffuse polarization.

### DESCRIPTION OF THE DRAWING

FIG. 1 is a functional diagram of the active polarization-resolving infrared imager.

FIG. 2 shows the active imager based on first-generation forward-looking infrared (FLIR) detector.

FIG. 3 illustrates a preferred embodiment of the active imager based on second-generation forward-looking infrared (FLIR) detector.

### DESCRIPTION OF THE PREFERRED EMBODIMENT

Referring now to the drawing wherein like numbers represent like parts in each of the several figures and solid lines with arrow heads indicate beam paths (unless otherwise stated in the drawing) while solid lines without arrow heads indicate mechanical or electronic connection, the structure and operation of active polarization-resolving infrared imager 100 (hereinafter referred to as “the active imager”) is explained in detail. As this active imager teaches a significant improvement of the passive means disclosed in U.S. Pat. No. 6,310,345, the teaching of U.S. Pat. No. 6,310,345 is hereby incorporated in its entirety into the instant application.

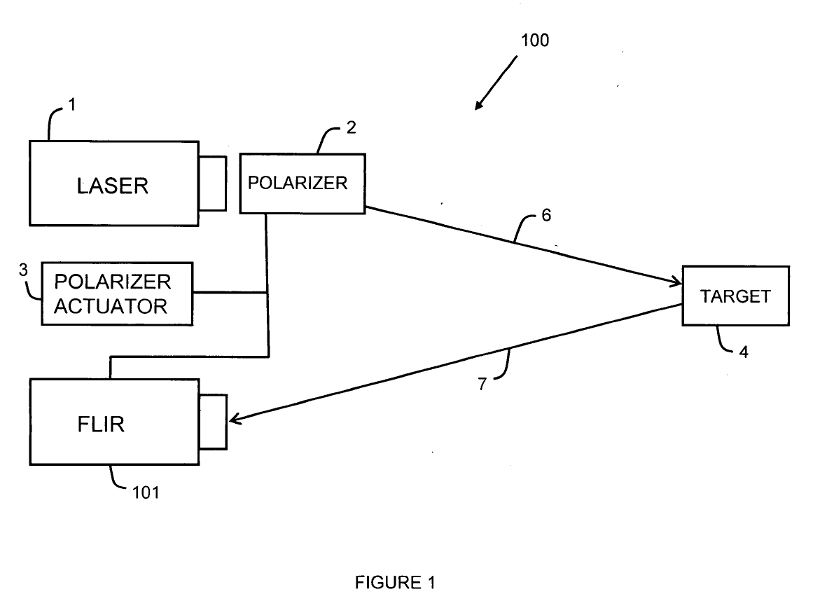

The passive mode of measurement utilized in U.S. Pat. No. 6,310,345 relies on the intensity of the received radiation which, in turn, depends on the time of the day, the angle of incidence and whether the article from which the radiation is received is hot or cold. There are many unknowns and uncontrolled factors associated with this mode. Actively illuminating the target scene would remove some of these unknowns and reduce the randomness. The active imager utilizes active reflectance which is a measurement of a known (wavelength, energy, pulse width, etc.) signal and which accounts for atmospheric conditions. Reflectance does not rely on the temperature of the items found in target scene 4 or the time (therefore ambient temperature of the environment) of the day. Rather, in active imager 100, functionally depicted in FIG. 1, laser 1 emits laser beam 6 toward target scene 4. The emitted beam passes through polarizer 2 that polarizes the beam in a pre-selected polarization orientation prior to being incident on the target. Various objects in the target scene then reflect the beam 7 some of which is received by forward-looking infrared (FLIR) imaging detector device 101. The degree of preservation of the original polarization present in received beam 7 is calculated to identify the nature of the target objects from which laser beam 6 had been reflected.

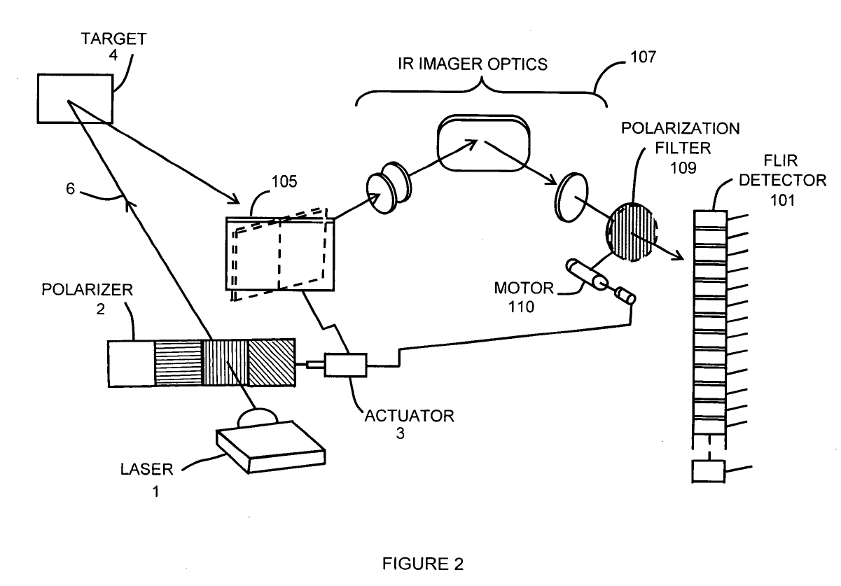

FIG. 2 shows the active imager implementation based on first-generation forward-looking infrared (FLIR) detector 101. Polarizer 2, which may be translatable or rotatable like polarization filter 109, is positioned between laser 1 and target scene 4 and is capable of selectively imparting 0, 45 or 90-degree polarization orientation or no polarization to the laser beam emitting from the laser. Actuator 3, coupled to polarizer 2 to set the polarizer to a pre-selected polarization orientation, is synchronized with motor 110 such that the polarization orientation of polarizer 2 and that of filter 109 is the same at any given point in time. The polarizer actuator must further be synchronized with tiltable scan mirror 105 to assure that the polarization orientation of emitted beam 6 is identical with the polarization of beam 7 received by detector 101. This results in return (received) signals being maximized on the items or articles in the target scene that preserve the original polarization. The items that preserve the polarization, such as geometric or regular structure, stand out against random nature background which tends to diffuse polarization. The user of the active imager is thus more accurately cued to non-naturally occurring areas or objects of interest due to relatively high degree of polarization preservation by such areas or objects.

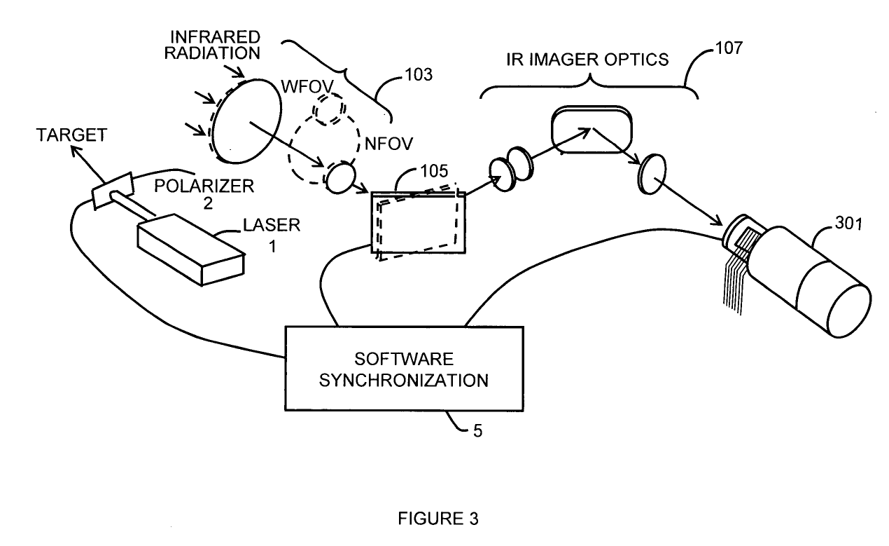

FIG. 3 illustrates the active imager implementation based on second-generation FLIR detector 301. In this embodiment, polarization filter 109 is eliminated altogether since the individual polarizers are pixel-sized and affixed to the detector elements as described in U.S. Pat. No. 6,310,345. The necessary synchronization between polarizer 2, scan mirror 105 and the detector-polarization combination units in device 301 is accomplished electronically by suitable software means 5.

In either of the implementations described above, laser 1 may emit either pulsed or continuous wave and the number of pulses emitted at a given polarization orientation can be varied to match the specific environmental conditions, thus providing the desired signal-to-noise ratio. Typically, the FLIR operates in wavelengths of 3 to 5 or 8 to 12 microns.

Although particular embodiments and forms of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

We claim:

1. In a passive system for detecting and processing incoming infrared radiation to output visible images therefrom, the system having an optical assembly for receiving and focusing the infrared radiation emanating from a target scene, a tiltable scan mirror having a pre-selected scan pattern, infrared imager optics for directing the infrared radiation in a pre-determined direction, a first-generation forward-looking infrared detector device to convert the infrared radiation into electrical signals, a rotatably-mounted polarization filter positioned to receive infrared radiation from the imager optics and separate the radiation into multiple portions, each portion having a different polarization, prior to transmitting the portions to the first-generation detector device, a motor for rotating the polarization filter, and processing electronics for receiving the electrical signals from the detector device and producing therefrom visible imagery descriptive of the target scene, AN IMPROVEMENT for reducing the randomness attendant upon passively received radiation, said IMPROVEMENT comprising: a laser for emitting laser beam toward the target scene; a polarizer positioned between said laser and target scene, said polarizer selectively polarizing the emitted beam at 0, 45 or 90 degrees; and an actuator, said actuator being coupled to drive said polarizer so as to enable said polarizer to polarize the emitted beam in a selective manner.

2. In a system for detecting and processing incoming infrared radiation to output visible images therefrom, an improvement as set forth in claim 1, wherein said actuator is synchronized with the tilt of the scan mirror and the motor rotating the polarization filter such that the polarization orientation of said polarizer and that of the filter is the same at any given moment in time.

3. In a system for detecting and processing incoming infrared radiation to output visible images therefrom, an improvement as set forth in claim 2, wherein said polarizer may be rotatably mounted or translatably mounted.

4. In a system for detecting and processing incoming infrared radiation to output visible images therefrom, an improvement as set forth in claim 3, wherein said polarizer selectively imparts no polarization orientation to the emitted beam.

5. In a passive system for detecting and processing incoming infrared radiation to output visible images therefrom, the system having an optical assembly for receiving and focusing the infrared radiation emanating from a target scene, a tiltable scan mirror having a pre-selected scan pattern, infrared imager optics for directing the infrared radiation in a pre-determined direction, a second-generation forward-looking infrared detector device to convert the infrared radiation into electrical signals, the detector device having multiple detector elements and corresponding number of polarization-filtering elements of varying polarization orientations integrated onto the detector elements, and processing electronics for receiving the electrical signals from the detector device and producing therefrom visible imagery descriptive of the target scene, AN IMPROVEMENT for reducing the randomness attendant upon passively received infrared radiation, said IMPROVEMENT comprising: a laser for emitting laser beam toward the target scene; a polarizer positioned between said laser and target scene, said polarizer selectively polarizing the emitted beam at 0, 45 or 90 degrees; and electronically synchronizing means, said synchronizing means being concurrently coupled between said polarizer, the scan mirror and the second-generation detector device, said synchronizing means synchronizing said polarizer, the scan mirror and the second-generation detector device such that the polarization orientation of emitted beam passing through said polarizer toward the target scene and the polarization orientation of the polarization-filtering elements receiving infrared radiation reflected from the target scene are identical at any given point in time.

6. In a system for detecting and processing incoming infrared radiation to output visible images therefrom as set forth in claim 5, wherein said emitted beam is either pulsed or continuous wave.
